(19) United States
(12) Patent Application Publication
(10) Pub. No.: US 2015/0070733 A1
(43) Pub. Date: Mar. 12, 2015

(54) SIMULTANEOUS DIGITAL IMAGE AND THE IMAGE FILE'S INTERNAL METADATA PRINTING SYSTEM

(71) Applicant: Joseph A. Bernardo, Stamford, CT (US)

(72) Inventor: Joseph A. Bernardo, Stamford, CT (US)

(21) Appl. No.: 14/538,086

(22) Filed: Nov. 11, 2014

Related U.S. Application Data
(63) Continuation-in-part of application No. 13/197,899, filed on Aug. 4, 2011.
(60) Provisional application No. 61/400,915, filed on Aug. 5, 2010.

(51) Int. Cl. G06F 3/12; H04N 1/00

(52) U.S. Cl. CPC G06F 3/1203; G06F 3/1222; G06F 3/1243; G06F 3/1238; H04N 1/00251; H04N 1/00461; H04N 2201/0082; H04N 2201/0084
USPC 358/3.28; 358/1.14; 358/1.15

(57) ABSTRACT

A system that simultaneously prints digital image files' images and image files' internal metadata. The details for a digital image may be printed onto the front side and/or back side of a picture's printed hardcopy while simultaneously printing the digital image file's internal metadata or simultaneously displaying the digital image with its file's internal metadata on electronic media such as televisions, desktop, laptop and tablet computer screens, digital picture frames, cell phone, smart phone and telephone displays, public billboards, Internet web pages and x-ray photographs. The digital picture's details, being presented in the subject system as a file's internal metadata, include but are not limited to the picture's file name, the photographer's name, a copyright holder's name and a description of the picture, as well as the picture's technical details such as its image format, date, GPS location, focusing mode, metering mode, shutter speed, flash exposure compensation, resolution, ISO sensitivity, white balance, etc. A unique image identification code, password protection and encryption, can be assigned to each image and incorporated in the image file's internal metadata.

### CROSS-REFERENCE TO RELATED APPLICATION

This application is a continuation-in-part of application Ser. No. 13/197,899, filed Aug. 4, 2011, which application claims the benefit of provisional application Ser. No. 61/400,915, filed Aug. 5, 2010, both of which are incorporated in their entirety herein by reference thereto.

### FIELD OF THE INVENTION

The present invention relates to improvements in simultaneous digital imaging systems and image file internal metadata printing systems and equipment.

### BACKGROUND OF THE INVENTION

As digital photography has grown to widespread acceptance and enormous popularity, photographers are faced with ever-mounting types and quantities of information and data for tracking and categorizing their work. This applies in varying degrees to professional photographers, serious amateurs and even hobbyists who wish to maintain, organize, protect or share their work.

Technical information relating to each image, known as metadata,¹ can be difficult to organize and maintain in a meaningful fashion, particularly as digital imaging proliferates and electronic storage costs diminish. Organization of images and data for thousands of photographs can be a growing and ongoing burden. ¹ According to Wikipedia, the free encyclopedia:

Metadata is “data about data.” The term is ambiguous, as it is used for two fundamentally different concepts (types). Structural metadata is about design and specification of data structures and is more properly called “data about the containers of data”; descriptive metadata, on the other hand, is about individual instances of application data, the data content.
Metadata are traditionally found in the card catalogs of libraries. As information has become increasingly digital, metadata are also used to describe digital data using metadata standards specific to a particular discipline. By describing the contents and context of data files, the quality of the original data/files is greatly increased. For example, a webpage may include metadata specifying what language it is written in, what tools were used to create it, and where to go for more on the subject, allowing browsers to automatically improve the experience of users. Wikipedia encourages the use of metadata by asking editors to add category names to articles, and to include information with citations such as title, source and access date.
The main purpose of metadata is to facilitate in the discovery of relevant information, more often classified as resource discovery. Metadata also helps organize electronic resources, provide digital identification, and helps support archiving and preservation of the resource. Metadata assists in resource discovery by “allowing resources to be found by relevant criteria, identifying resources, bringing similar resources together, distinguishing dissimilar resources, and giving location information.”
Wikipedia, the free encyclopedia, Metadata. <http://en.wikipedia.org/w/index.php?title=Metadata>(accessed Jun. 16, 2014).

Metadata describes other data. It provides information about a certain item's content. For example, an image may include metadata that describes how large the picture is, the color depth, the image resolution, when the image was created, and other data. A text document's metadata may contain information about how long the document is, who the author is, when the document was written, and a short summary of the document. Web pages often include metadata in the form of meta tags. Description and keywords meta tags are commonly used to describe the Web page's content. Most search engines use this data when adding pages to their search index.

These and other problems are addressed with the subject system and method which provides for simultaneous printing of digital image files' images and metadata, wherein both the image and metadata are contained, integrated, within the same, original, digital image file's data structure, without the use of external metadata sources such as sidecar files.

### SUMMARY OF THE INVENTION

The subject system provides for entering, changing and deleting of information specific to a digital image file's image and the image file's internal metadata and the subsequent simultaneous printing of said image and its image file's internal metadata. The image file's internal metadata for a digital image may be printed onto the front side and/or back side of a picture's printed hardcopy while simultaneously printing the digital picture. When the digital image is being displayed on electronic media such as televisions, desktop, laptop and tablet computer screens, digital picture frames, cell phone, smart phone and telephone displays, public billboards, Internet web pages and x-ray photographs the subject system also provides for the image file's internal metadata to be shown. Examples of a digital image file's internal metadata include but are not limited to the picture's file name, the photographer's name, a copyright holder's name and a description of the picture, as well as the picture's technical details such as its image format, date, GPS location, focusing mode, metering mode, shutter speed, flash exposure compensation, resolution, ISO sensitivity, white balance, and the like. Additionally, the image file's internal metadata may include a unique image identification (ID) which can be assigned to each image upon its creation, and which when combined with a password, will offer additional and valuable protection of the image metadata. The metadata for the subject system is internal to the subject image file's structure and exclusively limited to metadata contained wholly within the same file structure of the image to be printed and without the use of external metadata sources such as sidecar files.

The subject system also provides new methods for entering, changing and deleting a digital image's metadata. The system's preferred method for entering, changing and deleting a digital image file's internal metadata would be through the use of a touch screen keypad displayed on the digital camera's viewing screen. As discussed in further detail below, preferably, the touch screen keypad would only be made visible and enabled as an overlay at the photographer's discretion. Additional new methods for entering, changing and deleting a digital image file's internal metadata include use of cameras having built-in hardware keypads and/or pointing devices, cameras that support external keyboards and/or pointing devices. Using any combination of the aforementioned new data entry methods is also contemplated.

The subject system also encompasses utilizing a new class of printers, which are capable of printing digital image files' internal metadata onto the front side, back side, or both sides of a photograph while simultaneously printing the digital image file's image. Such printers can be located anywhere, such as at public kiosks typically found in drug stores, airports and hotels. Similar printers with the same two-sided metadata/image printing functionality are contemplated specifically for use in homes, businesses, government offices and the like.

It will be recognized that the foregoing improvements have been described with respect to a system associated with digital camera photography, it is contemplated that they can be applied to the entering, changing, deleting and the printing of any digital image file's internal metadata onto the front side and/or back side of the image's printed hardcopy while simultaneously printing the digital image file's image, regardless of the method by which the digital image was acquired. Some examples of other methods used to acquire digital images would include but are not limited to still images captured from digital movies, digital scanners, cell phones, smart phones, desktop, laptop and tablet computers, email, web pages, and the like.

Furthermore, the improved system and a variety of preferred embodiments are provided herein below. Each of which may be made and used in accordance with the methods detailed below.

Other objects, features and advantages of the invention will be apparent when the detailed descriptions of the preferred embodiments of the invention are considered with reference to the accompanying drawings, which should be construed in an illustrative and not limiting sense as follows.

### BRIEF DESCRIPTION OF THE DRAWINGS

FIG. 1 is schematic representation of an embodiment of the subject system.

FIG. 2 is a detail of the system shown in FIG. 1.

FIG. 3 is an elevation view of an apparatus which may be used in the system.

FIG. 4 is an alternative view of the apparatus shown in FIG. 3, depicting a touch keypad for controlling the manipulation of image files' internal metadata in accordance with the invention.

FIG. 5 is a schematic of another apparatus that may be used in the system.

FIG. 6 is an alternative view of the apparatus shown in FIG. 5, depicting a touch keypad overlay on a display for controlling the manipulation of image files' internal metadata in accordance with the invention.

FIG. 7 is a depiction of a hardcopy printout of an image with the image file's internal metadata printed as an overlay.

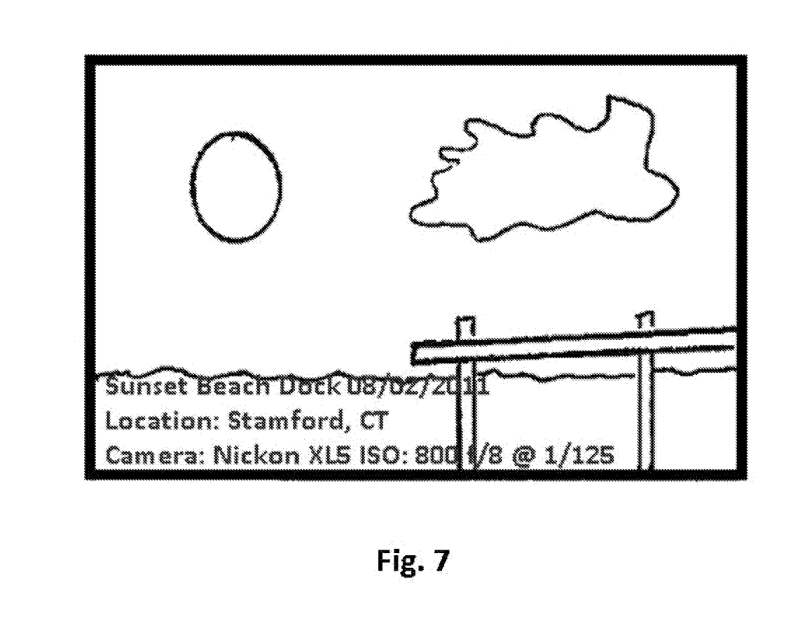

FIG. 8 is a depiction of a hardcopy printout of an image with the image file's internal metadata printed in a user defined area outside of the image itself

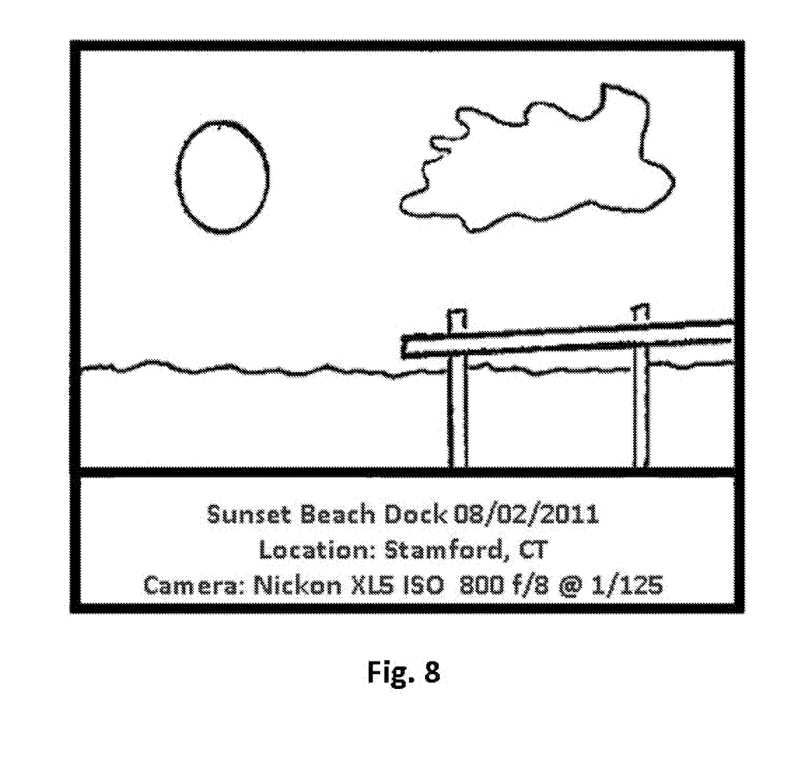

FIG. 9 is an alternative depiction of a hardcopy printout of an image with the image file's internal metadata printed in a user defined area outside of the image itself.

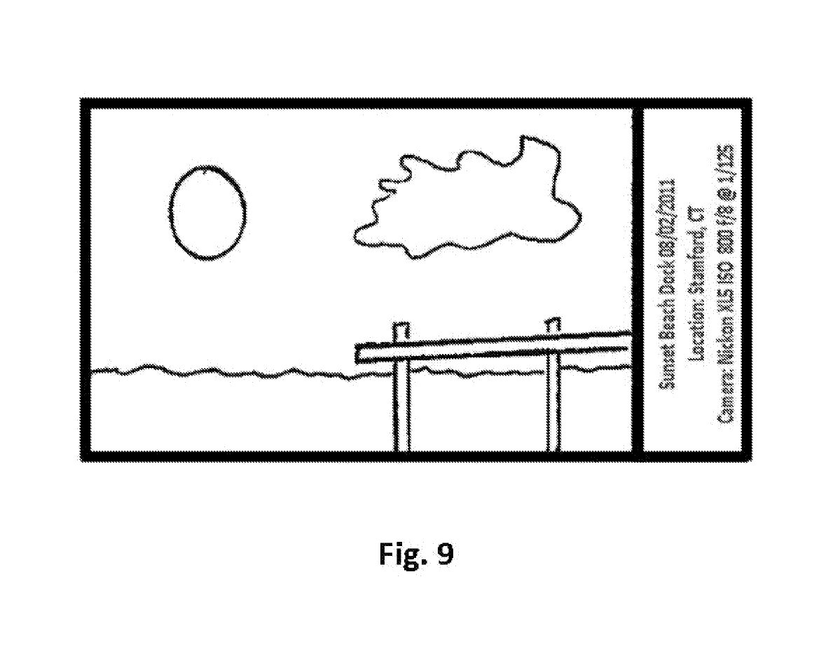

### DETAILED DESCRIPTION OF THE PREFERRED EMBODIMENTS

The subject apparatus and system have several important elements as detailed herein below.

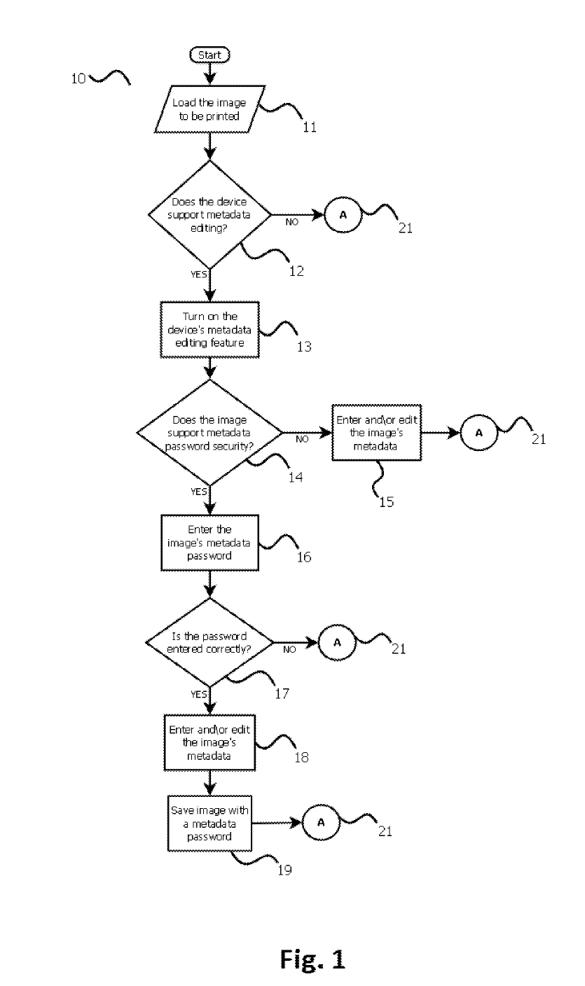

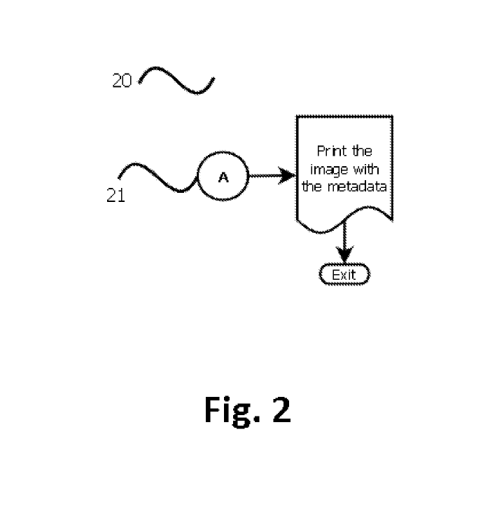

In FIG. 1, system 10 is shown as a sequence of steps for printing an image with its file's internal metadata 21, depicted in four instances following any of steps 12, 14, 17 or 19. FIG. 2 is a detail 20 of the system 10 seen in FIG. 1 and depicts in each four possible occurrences, image and image file's internal metadata printing step 21, also indicated by reference letter “A” in both figures. After printing an image with its file's internal metadata, the process ends and may be repeated as desired. Referring again to FIG. 1, the first step is loading the image for editing and printing 11. The image that is to be printed with its file's internal metadata information is loaded (i.e., displayed) on a device that is capable of entering and/or editing the image file's internal metadata. The image and its file's internal metadata to be printed can come from a data source built into the device or from an external source such as another digital camera, desktop, laptop or tablet computers, captured from a digital movie, digital scanners, cell phones, smart phone, emails, web pages, different forms of removable memory devices, and the like.

The device that would enter and or edit the image file's internal metadata would include but not be limited to:
a. a digital camera or other digital device with a touch screen keypad displayed on the digital device's viewing screen, such devices would include but not be limited to the Apple iPhone using iOS and Motorola Droid smartphones using the Android operating system. The touch screen keypad can be made visible and enabled as an overlay at the photographer's discretion, or
b. a digital camera or other digital device with built-in hardware keypads and/or pointing devices, or
c. a digital camera that supports external, peripheral, keyboards and/or touch screens and/or pointing devices, or
d. a digital device with the digital camera connected to it, thereby allowing the use of that device's keyboard and/or touch screen and/or pointing devices, or
e. a digital device with the discrete memory module containing the digital image connected to it by whatever means thereby allowing the use of that device's keyboard and/or touch screen and/or pointing devices, or
f. a printer capable of managing image security, image files' internal metadata editing and the simultaneous printing of the image and the image file's internal metadata onto either the image side or the reverse side of the hardcopy printout, or
g. a printer that would incorporate the functionality of the printing device described in above item f. with the added capabilities of copying, scanning and faxing of images, or
h. a computer and/or other device with metadata editing capability, with or without a proposed image password feature, or
i. voice recognition systems, or
j. any combination of the aforementioned devices.

Continuing the protocol for operating the subject apparatus and system, the next step after supporting metadata editing step 12 is turning on the device's metadata editing feature 13. The device's metadata editor, in whatever hardware, firmware, operating system, driver or software application form it may be, is started so that the image file's internal metadata is presented for viewing. Example methods for turning on a proposed device's metadata editor include but are not be limited to:
a. using a switch or button made onto the body of the device;
b. using the device's built-in menu system; or
c. if the device does not support image metadata editing the image and the file's internal metadata are sent directly to the proposed printer as outlined in connection with printing step 21 described below.

If the image supports metadata password security 14, it may be entered in step 16, otherwise the image may be edited and printed in steps 15 and 21. The proposed system would optionally incorporate an image password in step 17 to protect the property rights of the image creator/owner; the image creator/owner would configure the image password by assigning it a character string and/or by other methods. However, if the image does not use a metadata password then image and the image file's internal metadata are allowed to be entered and/or edited by the device's metadata editor, in whatever hardware, firmware, operating system, driver or software application form it may be and sent to the proposed printer as outlined in steps 15 and 21. If the image does use a metadata password and if the correct image metadata password is not entered the file's internal metadata is not allowed to be edited but the image and its unedited metadata are allowed to be sent to the proposed printer.

Upon entering and/or editing the image file's internal metadata in step 18, for images where passwords are used, enter, edit or delete the image file's internal metadata using metadata-editing software in whatever hardware, firmware, operating system, driver or software application form it may be. Such software would include but not be limited to Adobe Photoshop, Adobe Bridge, Microsoft Expression Media, Camerabits Photo Mechanic and the device's operating system's built-in metadata editing capability. For system devices using a built-in metadata editor, as outlined above, or any of the alternative data entry methods, enter, edit or delete the image file's internal metadata. Next, saving the image with a metadata password occurs in step 19. Saving the image with a metadata security password will help protect the creator's/owner's property rights. The image creator/owner may have the option of creating, modifying or deleting a metadata security password. The image creator/owner may have the option of encrypting or decrypting the image and/or metadata before saving the image and/or metadata.

Printing the image with its file's internal metadata occurs at each independent instance of step(s) 21, as shown in FIGS. 1 and 2. The image would be printed with the image file's internal metadata on the front side and/or back side of the hardcopy. All references to printing are to be understood as meaning printing hardcopies in color and/or black and white. As applied to the subject system, references to printing are also understood as simultaneously displaying the digital image with its file's internal metadata on electronic media such as televisions, desktop, laptop and tablet computer screens, digital picture frames, cell phone, smart phone and telephone displays, public billboards, Internet web pages and x-ray photographs and the like.

Hardcopy printing can be done by a printer capable of simultaneously printing the image subject on one side of a hardcopy and the image file's internal metadata on the front side and/or back side of the hardcopy.

The system would allow for the entering, changing and deleting of a digital photograph's details, also referenced as the image file's internal metadata, and the subsequent printing of those details onto the front side and/or back side of the photograph's printed hardcopy. As discussed above, examples of a digital photograph's details could include but not be limited to a photograph's file name, the photographer's name and a description of the photograph's subject as well as a photograph's technical details such as its image format, focusing mode, metering mode, shutter speed, flash exposure compensation, resolution, ISO sensitivity, white balance, etc.

It is further contemplated as part of this system that additional methods for entering, changing and deleting a digital photograph's details will be developed and will be useful herein.

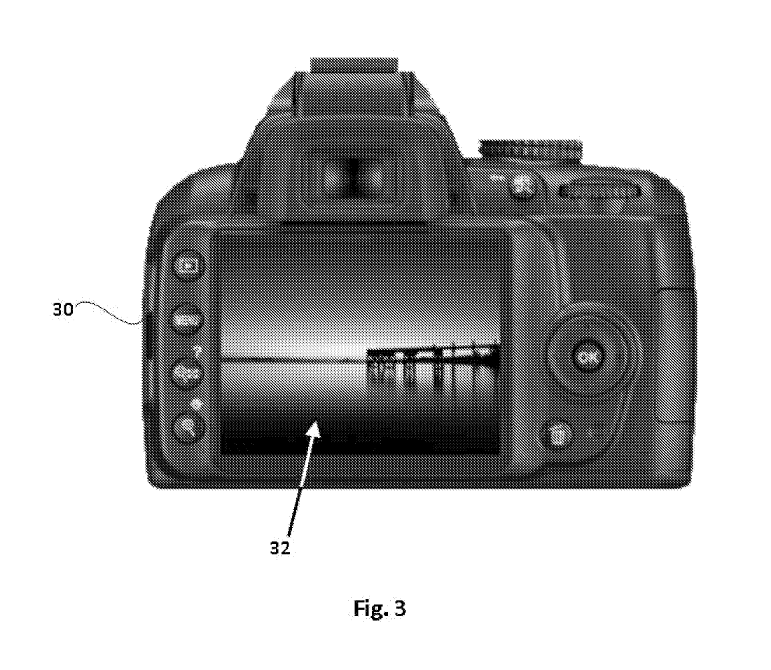

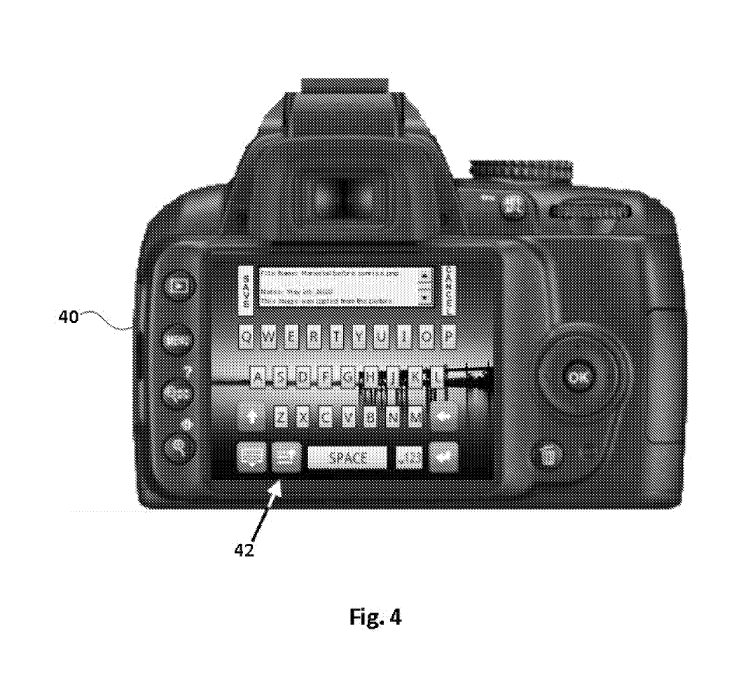

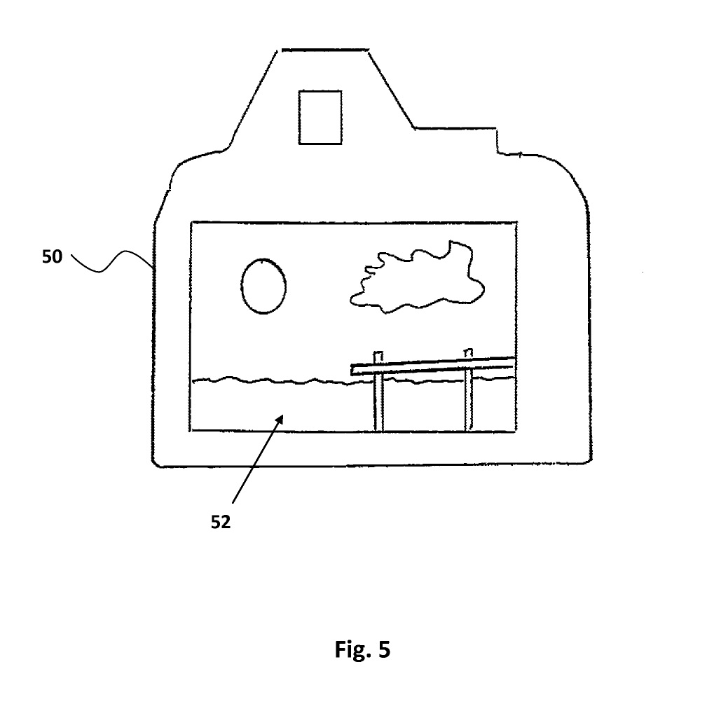

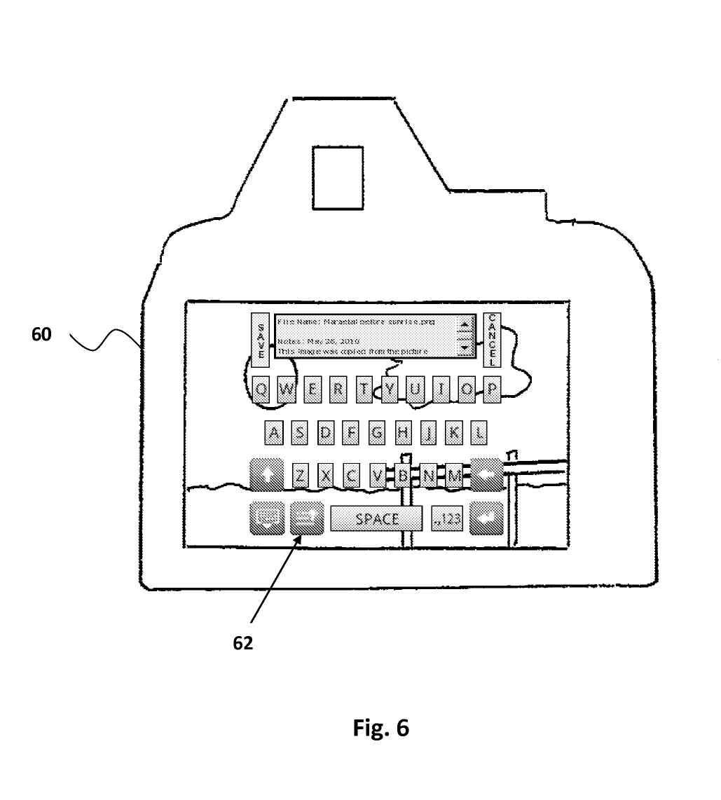

As mentioned, the system's preferred method for entering, changing and deleting a digital photograph's details would be through the use of a touch screen keypad displayed on the digital camera's viewing screen, as seen in FIGS. 3 and 4. FIG. 3 depicts camera 30 having a touch screen keypad 32, which has not yet been enabled by the photographer. In FIG. 4, touch screen keypad 42 has been enabled at the photographer's discretion and made visible as a QWERTY keyboard overlay on device 40. Similarly, FIG. 5 depicts a schematic diagram of camera 50 having a touch screen keypad-viewing screen 52, which has not yet been enabled by the photographer. In FIG. 6, touch screen keypad 62 has been enabled at the photographer's discretion and displays a QWERTY keyboard overlay on device 60. Other methods for entering, changing and deleting a digital photograph's details include the development of cameras having built-in hardware keypads and/or pointing devices, cameras that support external or USB keyboards and/or pointing devices, and cameras that support wireless and Bluetooth keyboards and/or pointing devices, all of which may be utilized in the subject system. Alternative methods for entering, changing and deleting a digital photograph's details also include connecting the digital camera, by whatever means, to a computer using that computer's keyboard and/or pointing devices. Also, if a discrete memory device containing the photograph is connected to a computer, by whatever means, using that computer's keyboard and/or pointing devices or by using any combination of the aforementioned data entry methods are considered to be part of the subject system.

It is also contemplated as part of this system that printing of a digital photograph's details onto the front side and/or back side of a photograph's printed hardcopy, may be accomplished in homes, businesses and public places on printers developed and/or retrofitted so as to have the above-described printing capabilities.

While the above proposals have specified a system associated with digital camera photography it is also the intention of these proposals that they be applied to the entering, changing, deleting and the subsequent printing of any digital image's details, also referenced as the image file's internal metadata, onto the front side and/or back side of the image's printed hardcopy regardless of the method by which the digital image was acquired.

In other embodiments of the subject system, the device that created the image (i.e. camera, cell phone etc.) would have the means to add a unique identification string to each of the device's image file's internal metadata thereby protecting the image creator's copyrights. One example of a unique identification string (image ID) would consist of the device's serial number added to a series of characters which then is applied to a password protected or unchangeable part of an image file's internal metadata when the image is created. This image ID may be visible in plain text or in a representative code such a bar code or a code of any other form when the image is printed with its file's internal metadata or when the image is viewed with its file's internal metadata on a display. In this example the device's serial number would initially be registered by the device's owner with the device manufacturer or an accredited organization that maintains such records. For this example once the device has been properly registered it will be used as part of the image ID for all images created on that device; the remainder of image IDs' characters would be in the form of date and the time when the image was created, with the time being accurate to 1/10000 of a second. If that image is then sold or otherwise released to someone else, a record of the image's ownership can be created using an image's unique ID. If the device is sold or otherwise released to someone else, a re-registration of the device's serial number by the new owner of the device would be required in order to claim copyright protection of future images.

The above is only one example of how image files' internal metadata can be implemented to protect the copyrights of an image owner therefore the specifics outlined in the example should not be construed as the only method available to the subject system to protect and document image ownership through the use of image metadata.

The invention now being fully described, it will be apparent to one of ordinary skill in the art that many changes and modifications can be made thereto without departing from the spirit or scope of the invention set forth herein.

1. A system that simultaneously prints digital image files' images and image files' internal metadata comprising the steps of:
a. loading a digital image file's image to be printed into a device capable of supporting digital image files' internal metadata editing;
b. enabling the metadata editing capability of the device;
c. loading and viewing the image file's internal metadata;
d. editing the image file's internal metadata as may be required; and
e. simultaneously printing the digital image file's image and the digital image file's internal metadata.

2. The system of claim 1 wherein the digital image file's internal metadata is printed as an overlay or in a user designated area upon the image of the same digital image file from which the internal metadata is retrieved.

3. The system of claim 1 wherein the image file's internal metadata is printed upon the reverse surface of the image of the same file from which the internal metadata is retrieved.

4. A system as in claim 1 further comprising the steps of enabling digital image files' internal metadata security requiring correct entry of a password key before permitting said files' internal metadata viewing, editing and printing; and otherwise printing an image with its unedited file's internal metadata.

5. A system as in claim 4 further comprising the step of saving an image file with an internal metadata password.

6. A system as in claim 1 further comprising the step of assigning a unique identification code to each digital image for image cataloging and demonstrating image ownership.

7. The system of claim 1, further comprising the step of password protecting the image file's internal metadata.

8. The system of claim 1, further comprising the step of encrypting the image.

9. The system of claim 1, further comprising the step of encrypting the image file's internal metadata.

10. A simultaneous digital image and the same image file's internal metadata printing apparatus comprising:
a. an image and metadata viewer;
b. a metadata editor configured with a data-entry input device;
c. a printer configured to print an image file's image and that same image file's internal metadata.

11. The apparatus of claim 10 wherein the metadata viewer is a touch screen keyboard overlaying the image contained within the same file as the internal metadata being viewed.

12. The apparatus of claim 10 further comprising an image file's internal metadata security password protection key for facilitating a file's internal metadata viewing, editing and printing.

13. An apparatus of claim 10 further comprising a unique identification code with each digital image for the purpose of image cataloging and ownership.

14. A simultaneous digital image capturing apparatus comprising:
a. an image and an image file's internal metadata viewer;
b. an image file's internal metadata editor configured with a data-entry input device.

15. The apparatus of claim 14, wherein the image file's internal metadata viewer is a touch screen keyboard overlaying the image file's image.

16. The apparatus of claim 14 further comprising an image file's internal metadata security password protection configured for facilitating an image file's internal metadata viewing, editing and printing.

17. The apparatus of claim 14, further comprising a unique-identification encoder configured to apply a unique-identification code to each digital image for image cataloging and ownership.

18. The apparatus of claim 14, further comprising a password protector for the image file's internal metadata.

19. The apparatus of claim 14, further comprising an image protector for encrypting an image file which includes the file's internal metadata.
